(19) United States
(12) Patent Application Publication
(10) Pub. No.: US 2008/0295313 A1
(43) Pub. Date: Dec. 4, 2008

(54) Manufacturing method for golf club head

(76) Inventor: Shih-Ta Chang, Hsinchu City (TW)

Correspondence Address: Muncy, Geissler, Olds & Lowe, PLLC, P.O. BOX 1364, FAIRFAX, VA, 22038-1364, US

(21) Appl. No.: 12/153,132

(22) Filed: May 14, 2008

(30) Foreign Application Priority Data
May 29, 2007 (CN) 200710103764.3

(51) Int. Cl. B23P 17/00; B23P 25/00

(52) U.S. Cl. 29/527.1; 29/557

(57) ABSTRACT

A manufacturing method for golf club head includes creating a striking plate blank and a club head body initially; disposing a pile of cladding powder on the back of said striking plate blank; heating said pile of cladding powder by a high-energy beam to form at least one protrusion on the back of said striking plate blank, so as to shape the striking plate; and coupling the striking plate to the club head body to form a golf club head.

### BACKGROUND OF THE INVENTION

1. Field of the Invention

The present invention relates to a manufacturing method for golf club head, and particularly to a manufacturing method heating a pile of cladding powder disposed on the back of a striking plate blank by a high-energy beam to form at least one protrusion thereon.

2. Description of Related Art

Conventionally, the following methods are applied to improve striking controllability and broaden a sweet spot of a golf club head. A Taiwan utility patent with Publication No. 561907 discloses a manufacturing method for striking plate by milling a flat plate having even thickness to form a striking plate with various thicknesses. In detail, the flat plate is preferably of titanium alloy or stainless steel, and a computer numeral controlled milling machine (CNC milling machine) is applied to mill the flat plate. For said striking plate, a section of the striking plate with a largest thickness is disposed at the center of the striking plate as a sweet spot of a golf club head with the striking plate. On the contrary, a section of the striking plate with a smallest thickness may provide a good elastic deformability. Therefore, a striking plate made by said manufacturing method and having various thicknesses would provide good striking controllability and stability.

Another Taiwan utility patent with Publication No. 294960 also discloses a manufacturing method for striking plate, with a disclosed striking plate being a composite striking plate formed by a first plate for ball-striking and a second plate for structure-enhancing. During manufacturing, the second plate goes through a milling process, etching process, grinding process or a combination thereof to remove undesired parts, so as to form an enhancing protrusion and a plurality of ribs. After assembly, with a rear side of the first plate facing the protrusion and ribs of the second plate and a front side of the first plate utilized for ball-striking, the second plate is coupled with the first plate to provide an enhanced structural strength of the striking plate. Moreover, owing to the material of the second plate, which has high absorbability, the striking plate thereby has excellent absorbability and structural strength.

However, there are still some drawbacks of said conventional manufacturing methods. For example, either striking plate with single plate or double plates is produced by milling for removing undesired parts so as to form the protrusion or ribs, but these processes induce large processing time and a great amount of wasted material. Hence, there is a need for improving the conventional manufacturing method for golf club head.

### SUMMARY OF THE INVENTION

An object of the present invention is to provide a manufacturing method for golf club head to decrease manufacturing cost and raise work efficiency.

Another object of the present invention is to increase strength and reliability of connection between a striking plate blank and at least one protrusion.

A manufacturing method for golf club head in accordance with the present invention comprises creating a club head body and a striking plate blank initially; forming at least one protrusion on the back of the striking plate blank to shape a striking plate; and coupling the striking plate to the club head body with the at least one protrusion facing inwardly to form a golf club head, wherein the manufacturing method is characterized in that the at least one protrusion is formed by disposing a pile of cladding powder on the back of the striking plate blank and heating said pile of cladding powder by a high-energy beam.

Preferably, the high-energy beam is emitted and moves along a route in which the cladding powder is disposed for forming the at least one protrusion into at least one predetermined shape.

Preferably, the high-energy beam is selected from an high-energy ion beam or a high-energy laser beam.

Preferably, the striking plate blank and cladding powder are in an space filled with protecting gas for separating said striking plate blank and cladding powder from outer air and dust when said pile of cladding powder is headed.

Preferably, the cladding powder is of a material being the same or different but compatible with that of the striking plate blank.

Preferably, the cladding powder is disposed onto the back of the striking plate blank by jetting gas flow, pre-coating a powder bed or gravitative piling.

Preferably, a process for surface treatment is performed for surfaces of the striking plate and club head body, after the striking plate being shaped, and before the striking plate and club head body being coupled together.

Other objects, advantages and novel features of this invention will become more apparent from the following detailed description when taken in conjunction with the accompanying drawings.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating a manufacturing method for golf club head in accordance with the present invention; and

FIG. 2 is an exploded perspective view illustrating a golf club head made by the manufacturing method for golf club head in accordance with the present invention.

### DETAILED DESCRIPTION OF THE INVENTION

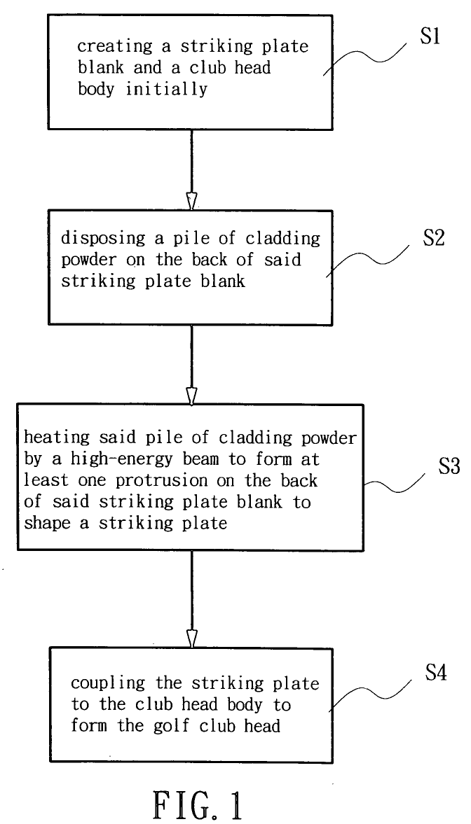

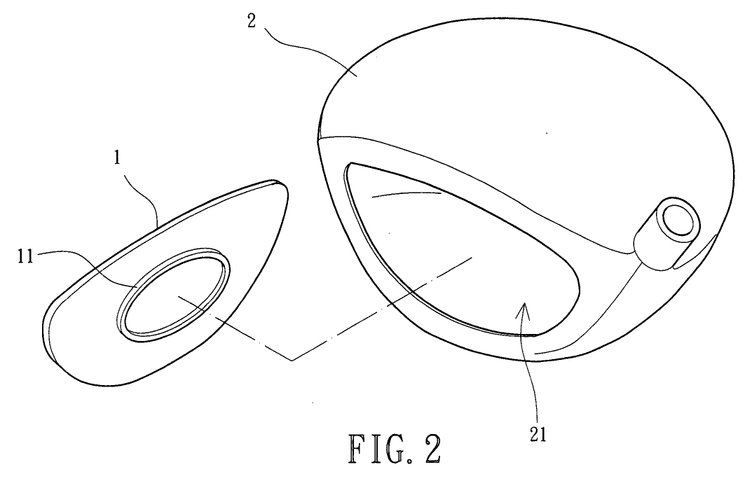

Referring to FIGS. 1 and 2, a manufacturing method for golf club head and a produced golf club head thereby in accordance with the present invention is illustrated, wherein the golf club head is formed by combining an enhanced striking plate 1 and a club head body 2. The manufacturing method comprises steps as a first step S1, “creating a striking plate blank and the club head body 2 initially”, a second step S2, “disposing a pile of cladding powder on the back of said striking plate blank”, a third step S3, “heating said pile of cladding powder by a high-energy beam to form at least one protrusion 11 on the back of said striking plate blank, so as to shape the striking plate 1”, and a fourth step S4, “coupling the striking plate 1 to the club head body 2 to form the golf club head”. Further details of the manufacturing method are illustrated as the following.

The first step S1, “creating a striking plate blank and a club head body 2”, is performed with both the striking plate blank and club head body 2 being of a metal such as stainless steel, carbon steel, alloy steel, maraging steel, copper alloy, aluminum alloy, magnesium alloy, iron alloy, titanium alloy or a mixture of at least two of them. Furthermore, the striking plate blank and club head body 2 are created by executing machine processes such as punching, forging, casting or laser bean cutting on pieces of selected metal.

The second step S2, “disposing a pile of cladding powder on the back of said striking plate blank”, is performed as the following. A powder feeder is utilized to dispose the cladding powder on the back of said striking plate blank through jetting gas flow. Moreover, air for carrying the cladding powder is preferably selected from inert gases, and more preferably selected from argon. Besides, the cladding powder can also be disposed onto the back of said striking plate blank by pre-coating a powder bed or gravitative piling.

The third step S3, “heating said pile of cladding powder by a high-energy beam to form said at least one protrusion 11”, is performed with the high-energy beam being selected from an high-energy ion beam or a high-energy laser beam. Furthermore, an opening for emitting the high-energy beam and that or those for spraying the cladding powder are in a relationship of separated form, coaxial form or satellite-coaxial form, which are respectively disclosed in U.S. Pat. No. 6,122,564, No. 4,724,299 and No. 6,534,745. And a nozzle has openings for emitting the high-energy beam and for spraying the cladding powder being arranged in said satellite-coaxial form is preferable.

In fact, the second and third steps are almost executed simultaneously; that is, when the cladding powder is first sprayed and disposed on the back of the striking plate blank by the nozzle, the high-energy beam is then emitted by the nozzle and heat the disposed cladding powder immediately. And with a route wherein the nozzle moves, the cladding powder is continuously disposed while the high-energy beam is continuously emitted to heat the disposed cladding powder. Besides, the route is previously determined, so as to pile and heat the cladding powder along the route for forming the at least one protrusion 11 into at least one predetermined shape. Said route can be arranged as the circumference of a circle, as shown in FIG. 2, as that of any polygon such as rectangle, or as any geometric figure. Therefore, by the second and third steps, the striking plate 1 is produced, with a welding layer formed between the at least one protrusion 11 and the striking plate blank. Consequently, through the at least one protrusion 11, the striking plate 1 thereby have various thicknesses such that the striking plate 1 can provide a good coefficient of restitution (COR) and a wide sweet spot.

In addition, when the third step is executed, the striking plate blank and cladding powder are in a space filled with protecting gas for separating said striking plate blank and cladding powder from outer air and dust. Said protecting gas is also preferably selected from inert gases, and more preferably selected from helium. The protecting gas may prevent the striking plate blank and cladding powder from being touched by oxygen, hydrogen, nitrogen or other gas contained in the outer air; thereby, oxidation or other chemical reactions are avoided. As a result, gas holes or oxides that may weaken strength of connection between the striking plate blank and the at least one protrusion 11 are absent. Besides, the cladding powder is preferably of a material being the same with or different but compatible with that of the striking plate blank, so as to further increase the strength and reliability of connection between the striking plate blank and said at least one protrusion 11.

The fourth step S4, “coupling the striking plate 1 to an opening 21 of the club head body 2 with the at least one protrusion 11 facing inwardly to form the golf club head”, is performed while the striking plate 1 is completely shaped. Moreover, before the striking plate 1 being coupled to the club head body 2, a process for surface treatment such as grinding, polishing, surface hardening or carving process can be performed for surfaces of the striking plate 1 and club head body 2 to have hard surface, beautiful appearance and functions such as rust resistance, corrosion resistance and identifiably.

By the above manufacturing method for golf club head, the striking plate 1 with the at least one protrusion 11 is formed without milling, etching, grinding and cutting processes. That is, a striking plate blank that is larger than the shaped striking plate 1 and sustains said processes for forming the striking plate 1 is needless, so that the wasted material and time for producing the striking plate 1 is saved. And therefore manufacturing cost is decreased and work efficiency is raised. Moreover, owing to a high energy density of the utilized high-energy beam, an effected area of the striking plate 1 and a deforming amount of the effected area are thereby minimized. Besides, the utilized high-energy beam with high energy density can also make the welding layer be a dense structure and further raise the striking controllability.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A manufacturing method for golf club head comprising:
creating a club head body and a striking plate blank initially;
forming at least one protrusion on the back of the striking plate blank to shape a striking plate; and
coupling the striking plate to the club head body with the at least one protrusion facing inwardly to form a golf club head,
wherein the manufacturing method is characterized in that the at least one protrusion is formed by disposing a pile of cladding powder on the back of the striking plate blank and heating said pile of cladding powder by a high-energy beam.

2. The manufacturing method for golf club head as claimed in claim 1, wherein the high-energy beam is emitted and moves along a route in which the cladding powder is disposed for forming the at least one protrusion into at least one predetermined shape.

3. The manufacturing method for golf club head as claimed in claim 1, wherein the high-energy beam is selected from an high-energy ion beam or a high-energy laser beam.

4. The manufacturing method for golf club head as claimed in claim 1, wherein the striking plate blank and cladding powder are in a space filled with protecting gas for separating said striking plate blank and cladding powder from outer air and dust when said pile of cladding powder is headed.

5. The manufacturing method for golf club head as claimed in claim 1, wherein the cladding powder is of a material being the same with that of the striking plate blank.

6. The manufacturing method for golf club head as claimed in claim 1, wherein the cladding powder is of a material being different but compatible with that of the striking plate blank.

7. The manufacturing method for golf club head as claimed in claim 2, wherein the cladding powder is disposed onto the back of the striking plate blank by jetting gas flow, pre-coating a powder bed or gravitative piling.

8. The manufacturing method for golf club head as claimed in claim 7, wherein an air for carrying the cladding powder is selected from inert gases when disposing the cladding powder by jetting gas flow.

9. The manufacturing method for golf club head as claimed in claim 4, wherein the protecting gas is selected from inert gases.

10. The manufacturing method for golf club head as claimed in claim 1, wherein a process for surface treatment is performed for surfaces of the striking plate and club head body, after the striking plate being shaped, and before the striking plate and club head body being coupled together.

11. The manufacturing method for golf club head as claimed in claim 10, wherein the surface treatment is grinding, polishing, surface hardening or carving process.

12. A manufacturing method for striking plate of golf club head comprising:
creating a striking plate blank initially;
forming at least one protrusion on the back of the striking plate blank to shape a striking plate,
wherein the manufacturing method is characterized in that the at least one protrusion is formed by disposing a pile of cladding powder on the back of the striking plate blank and heating said pile of cladding powder by a high-energy beam.
